(19) United States
(12) Patent Application Publication
(10) Pub. No.: US 2004/0073940 A1
(43) Pub. Date: Apr. 15, 2004

(54) Broadband modem and method of processing incoming calls thereby

(75) Inventors: Ming-Chieh Chen, Hsinchu (TW); Shu-Ken Lin, Changhua (TW); Ching-Mao Yeh, Kaohsiung (TW)

Correspondence Address: Richard P. Berg, Esq., c/o LADAS & PARRY, Suite 2100, 5670 Wilshire Boulevard, Los Angeles, CA, 90036-5679, US

(73) Assignee: Ambit Microsystems Corporation

(21) Appl. No.: 10/637,817

(22) Filed: Aug. 6, 2003

(30) Foreign Application Priority Data
Oct. 11, 2002 (TW) 91123488

(51) Int. Cl. H04J 1/02; H04N 7/173

(52) U.S. Cl. 725/111; 725/106; 370/493; 370/494; 370/495

(57) ABSTRACT

A method for a broadband modem to process incoming calls. The broadband modem is coupled to a PSTN (public switched telephone network) and a VoIP network. First, an call is incoming by the broadband modem. Then, the broadband modem detects whether the incoming call is routed from the PSTN network or the VoIP network. When the incoming call is routed from the PSTN network, the broadband modem establishes a connection between a telephone coupled to the broadband modem and the PSTN network through a switch. When the incoming call is routed from the VoIP network, the broadband modem establishes a connection between the telephone and the VoIP network through the switch.

### BACKGROUND OF THE INVENTION

1. Field of the Invention

The present invention relates to an application for telephone communication service and particularly to a broadband modem and method of processing incoming calls thereby.

2. Description of the Prior Art

Several communication technologies provide different telephone communication services. Telephone communication services comprise POTS (Plain Old Telephone Service) and VoIP (Voice-over-Internet Protocol) service. POTS is popular for standard telephone communications. When one telephone is coupled to the PSTN (public switched telephone network), the user of the telephone is served by POTS. VoIP is a protocol for transmitting voice and image packets through an open network to provide telephone communication service. The benefit of VoIP service is that subscribers can pay a local dial-up fee and achieve long distance call service via Internet access when a call agent exists in the service, and thereby reduce telephone fees. The drawback is that the communication quality is not stable. If Internet service or a call agent is not available or system noise is prohibitive, for example, communication quality is compromised. Telephone fees for POTS are much higher than VoIP service, but the communication quality is more stable in the network environment today.

Products providing telephone communication service on the market cannot support POTS and VoIP service at the same time, such that users must provide a separate dedicated telephone system for each protocol, presenting considerable inconvenience.

### SUMMARY OF THE INVENTION

The object of the present invention is to provide a method for a broadband modem to process incoming calls. Using the method, the broadband modem respectively processes incoming calls from a PSTN network and a VoIP network.

An object of the present invention is to provide a broadband modem using the above method. Users can use one telephone to receive VoIP incoming calls and PSTN incoming calls, respectively. Thus, convenience is increased.

The present invention provides a method for a broadband modem to process incoming calls. The broadband modem is coupled to a PSTN (public switched telephone network) and a VoIP network. First, an incoming call is received by the broadband modem. Then, the broadband modem detects whether the incoming call is routed from the PSTN network or the VoIP network. If the incoming call is routed from the PSTN network, the broadband modem establishes a connection between a telephone coupled to the broadband modem and the PSTN network through a switch. If the incoming call is routed from the VoIP network, the broadband modem establishes a connection between the telephone and the VoIP network through the switch. Furthermore, when the broadband modem receives at least two incoming calls routed from the PSTN network and the VoIP network respectively at the same time, according to a predetermined priority, the broadband modem establishes a connection between the telephone and the VoIP network or the PSTN network through the switch.

Furthermore, the present invention also provides a broadband modem using the above method. The broadband modem comprises a first receiving port, a second receiving port, a telephone connecting port, a switch and a processor. The first receiving port is coupled to a PSTN network for receiving incoming calls from the PSTN network. The second receiving port is coupled to a VoIP network for receiving incoming calls from the VoIP network. The connecting port is coupled to a telephone. The switch connects the telephone to the PSTN network or the VoIP network selectively. The processor controls the connection of the switch. When an incoming call routed from the PSTN network is received by the first receiving port, the processor establishes a connection between the telephone and the PSTN network through the switch. When an incoming call routed from the VoIP network is received by the second receiving port, the processor establishes a connection between the telephone and the VoIP network through the switch.

The processor further comprises means for controlling a predetermined priority. When at least two incoming calls are received from the first receiving port and the second receiving port respectively at the same time, according to the predetermined priority, the processor establishes a connection between the telephone and the VoIP network or the PSTN network through the switch.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIGS. 1a and 1b are flowcharts illustrating a method for a broadband modem to process incoming calls according to the present invention.

FIG. 2 is a block diagram illustrating a broadband modem according to the invention.

FIG. 3 is the structure of the telephone system comprising the broadband modem shown in FIG. 2.

### DETAILED DESCRIPTION OF THE INVENTION

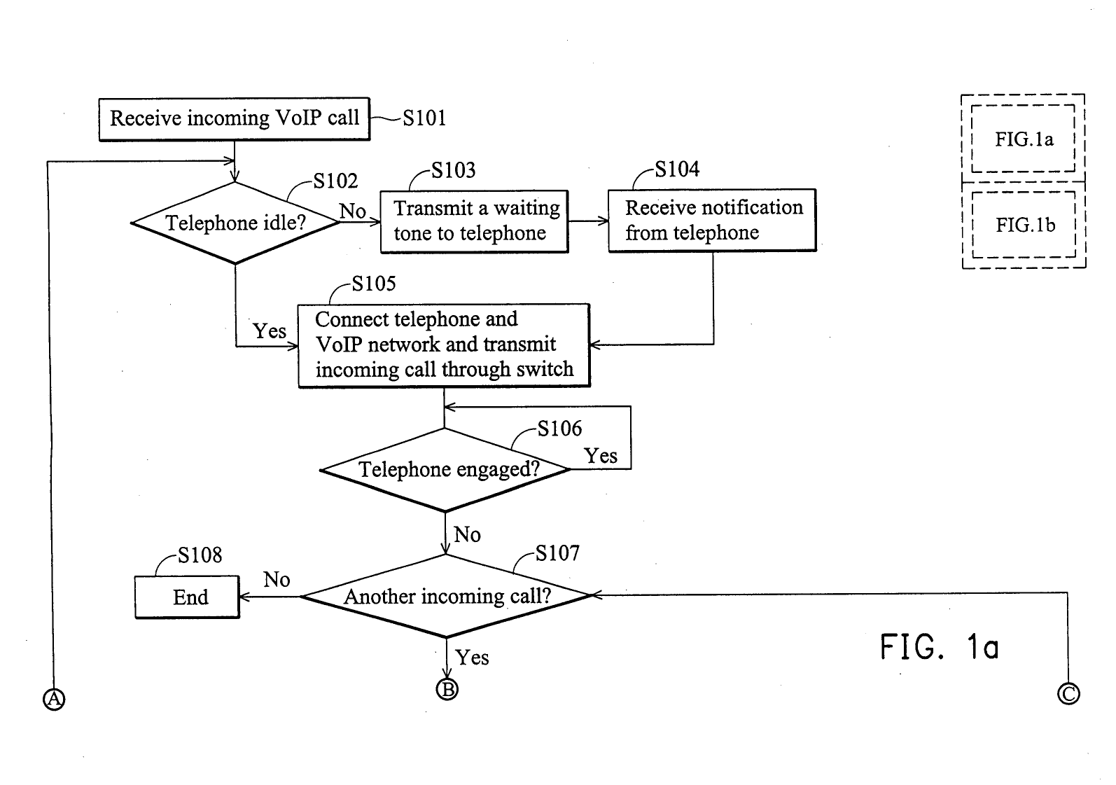

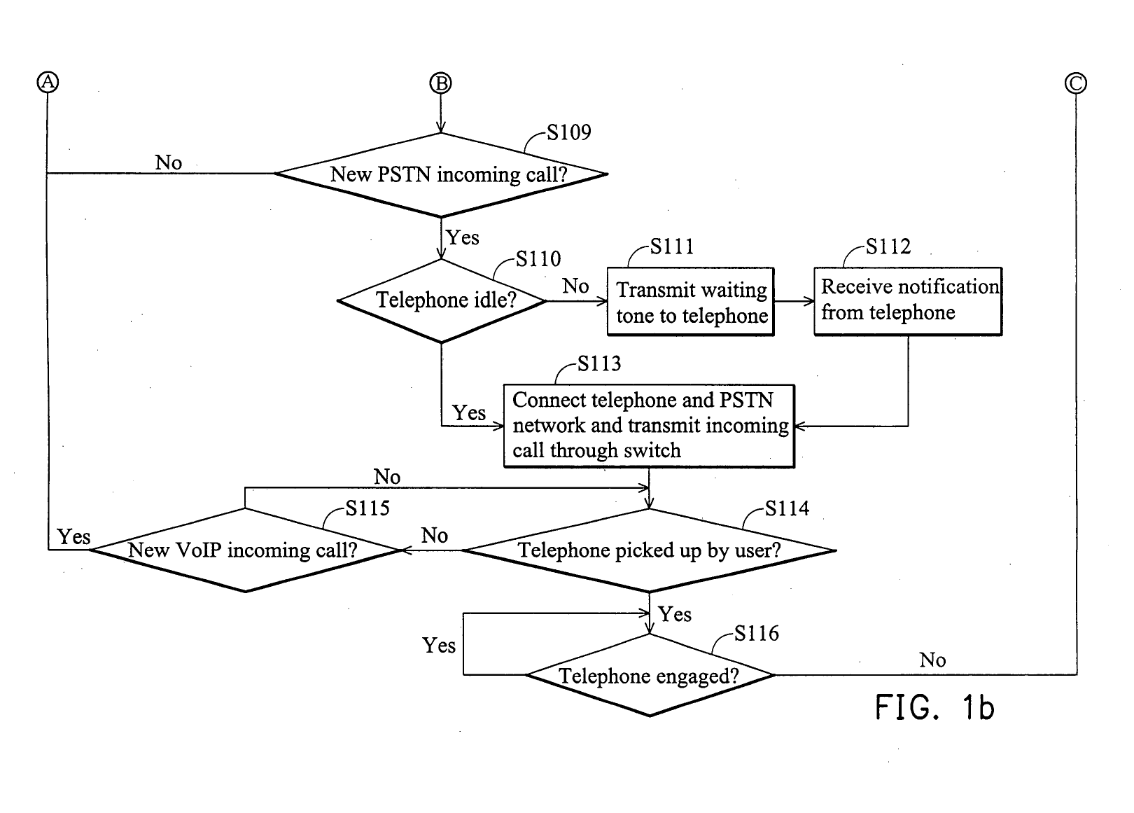

FIGS. 1a and 1b are flowcharts illustrating a method for a broadband modem to process incoming calls according to the present invention. In the embodiment, the broadband modem receives a VoIP incoming call first. If the broadband modem receives two incoming calls from a PSTN network and a VoIP network respectively at the same time, the broadband modem first establishes a connection between the telephone and the VoIP network through a switch.

As shown in FIGS. 1a and 1b, an incoming VoIP call is received by the broadband modem first (S101). Then, a detector of the broadband modem detects whether a telephone corresponding to the incoming VoIP call is idle (S102). If the telephone is not idle, i.e. engaged, the broadband modem transmits a waiting tone to the telephone (S103). After receiving a notification transmitted from the telephone, such as flash hook (S104), a processor of the broadband modem controls the switch to connect between the telephone and the VoIP network to transmit the incoming call to the telephone (S105). If the telephone is idle, the processor proceeds directly to step S105, i.e. controls the switch to connect between the telephone and the VoIP network to transmit the incoming call to the telephone.

Users of the telephone can determine whether to pick up the incoming call. Thus, the broadband modem continuously detects whether the telephone is engaged until the line becomes idle (S106). When the line becomes idle i.e. the telephone is not engaged, the broadband modem determines whether another incoming call is present (S107). If not, the process is ended (S108). If the broadband modem receives a new incoming call, whether the new incoming call is a PSTN incoming call is determined (S109). If the new incoming call is not a PSTN incoming call i.e. the new incoming call is a VoIP incoming call, step S102 is repeated.

If the new incoming call is a PSTN incoming call, the detector of the broadband modem detects whether a telephone corresponding to the PSTN incoming call is idle (S110). If the telephone is not idle, i.e. the telephone is engaged, the broadband modem transmits a waiting tone to the telephone (S111). After receiving a notification transmitted from the telephone (S112), a processor of the broadband modem controls the switch to connect between the telephone and the PSTN network to transmit the incoming call to the telephone (S113). If the telephone is idle, the processor proceeds directly to step S113, i.e. controls the switch to connect between the telephone and the PSTN network to transmit the incoming call to the telephone.

Users of the telephone can determine whether to pick up the incoming call. Thus, the broadband modem detects whether the incoming call is picked up by the users (S114) If the incoming call is not picked up by the users, the broadband modem determines whether a new VoIP incoming call is present (S115). If The broadband modem receives a new VoIP incoming call, step S102 is repeated. If no incoming VoIP call is present, step S114 is repeated.

If the incoming call is picked up, i.e. users initiate telephone communication through the PSTN network, the broadband modem continuously detects whether the telephone is engaged until the line becomes idle (S116). When the line becomes idle, i.e. the telephone is not engaged, step S107 is repeated.

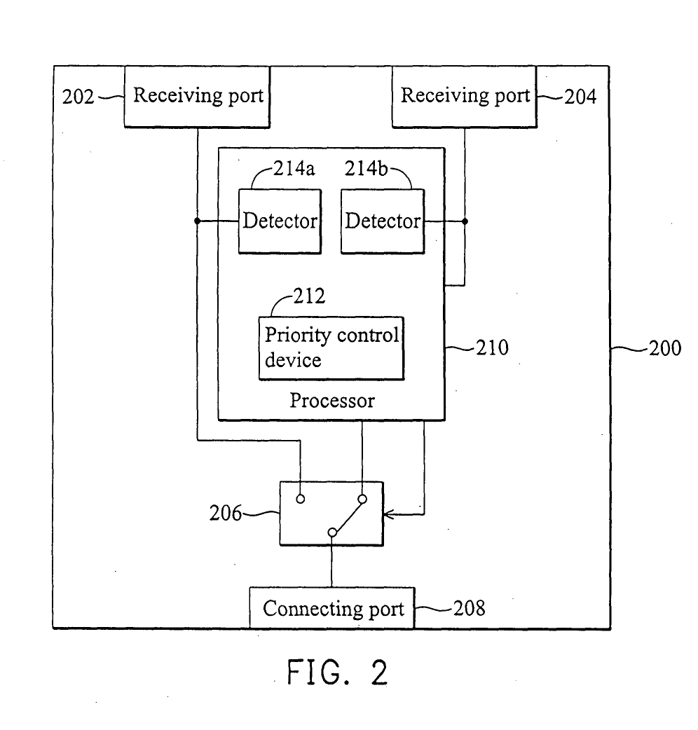

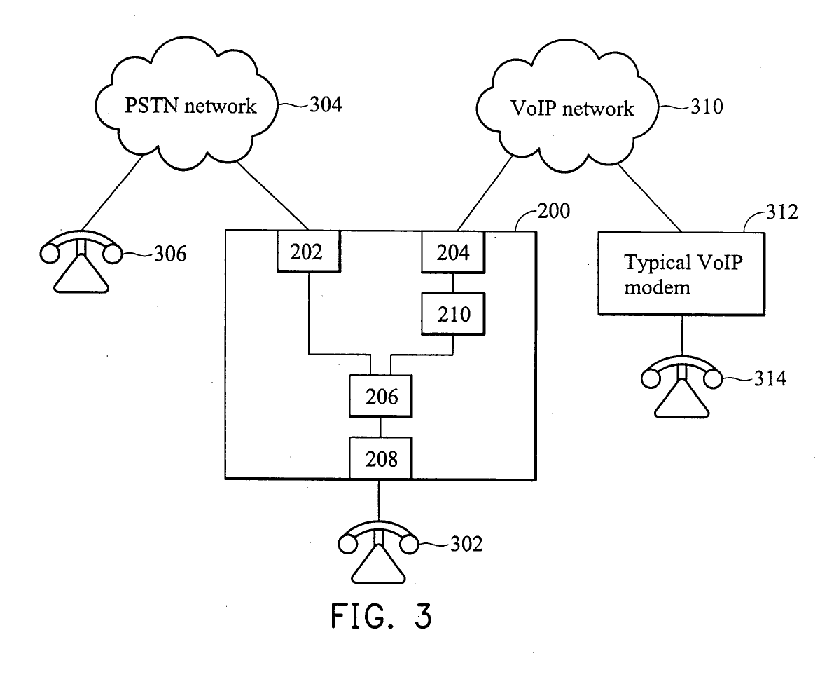

FIG. 2 is a block diagram illustrating a broadband modem according to the invention. As shown in FIG. 2, the broadband modem 200 comprises a PSTN receiving port 202, a VoIP receiving port 204, a switch 206, a telephone connecting port 208, and a processor 210. The PTSN receiving port 202 is coupled to a PSTN network for receiving incoming calls from the PSTN network (referring to FIG. 3). The VoIP receiving port 204 is coupled to a VoIP network for receiving incoming calls from the VoIP network (referring to FIG. 3). The telephone connecting port 208 is coupled to a telephone (referring to FIG. 3). While the boradband modem according to the present invention may comprise several connecting ports coupled to a plurality of telephones, in the present embodiment, a connecting port 208 coupled to only one telephone is used as an example. The switch 206 connects the telephone to the PSTN network or the VoIP network selectively. The processor 210 controls the connection of the switch. When an incoming call is routed from the PSTN receiving port 202, the processor 210 establishes a connection between the telephone and the PSTN network through the switch 206. When an incoming call is routed from the VoIP receiving port 204, the processor 210 establishes a connection between the telephone and the VoIP network through the switch 206.

The processor 210 further comprises a priority control device 212 and detectors 214a and 214b. When at least two incoming calls are received from the PSTN receiving port 202 and the VoIP receiving port 204 respectively at the same time, according to a predetermined priority set by the priority control device 212, the processor 210 establishes a connection between the telephone and the VoIP network or the PSTN network through the switch 206. In the present embodiment, if the broadband modem receives two incoming calls from a PSTN network and a VoIP network respectively at the same time, the scheme that the processor 210 first establishes a connection between the telephone and the VoIP network through the switch is used as an example.

When an incoming call is routed from the PSTN receiving port 202, the detector 214a detects whether the telephone is idle. If the telephone is idle, the processor 210 controls the switch 206 to connect between the telephone and the PSTN network to transmit the incoming call to the telephone. If the telephone is not idle, the processor 210 transmits a waiting tone to the telephone. After receiving a notification transmitted from the telephone, the processor 210 controls the switch 206 to connect between the telephone and the PSTN network to transmit the incoming call to the telephone.

When an incoming call is routed from the VoIP receiving port 204, the detector 214b detects whether the telephone is idle. If the telephone is idle, the processor 210 controls the switch 206 to connect between the telephone and the VoIP network to transmit the incoming call to the telephone. If the telephone is not idle, the processor 210 transmits a waiting tone to the telephone. After receiving a notification transmitted from the telephone, the processor 210 employs the switch 206 to connect between the telephone and the VoIP network to transmit the incoming call to the telephone.

FIG. 3 shows the structure of the telephone system comprising the broadband modem shown in FIG. 2. Referring to FIG. 2 and FIG. 3 at the same time, the broadband modem 200 is coupled to one telephone 302, although the broadband modem 200 can be coupled to a plurality of telephones. In the present embodiment, a broadband modem coupled to only one telephone is used as an example.

The PSTN receiving port 202 is coupled to a PSTN network 302. A typical telephone 306 is coupled to the PSTN network 304. The VoIP receiving port 204 is coupled to a VoIP network 310. Another telephone 314 is coupled to a typical VoIP modem 312, then to the VoIP network 310.

Using the broadband modem 200, the user of the telephone 302 can receive incoming calls from users of telephones 306 and 314 through the PSTN network 304 and the VoIP network 310, respectively. In other words, two telephones for receiving incoming calls from the PSTN network 304 and the VoIP network 310 respectively are not required.

Using the method for a broadband modem to process incoming calls provided by the invention, the broadband modem respectively processes incoming calls from a PSTN network and a VoIP network. Users can use one telephone to receive VoIP incoming calls and PSTN incoming calls, respectively. Thus, convenience is increased.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for a broadband modem to process an incoming call, wherein the broadband modem is coupled to a PSTN (public switched telephone network) and a VoIP (Voiceover-Internet Protocol) network, the method comprising:
receiving an incoming call by the broadband modem;
detecting whether the incoming call is routed from the PSTN network or the VoIP network;
when the incoming call is routed from the PSTN network, establishing a connection between a telephone coupled to the broadband modem and the PSTN network through a switch; and
when the incoming call is routed from the VoIP network, establishing a connection between the telephone and the VoIP network through the switch.

2. The method as claimed in claim 1, further comprising:
when at least two incoming calls routed from the PSTN network and the VoIP network respectively are received at the same time by the broadband modem, establishing a connection between the telephone and the VoIP network or the PSTN network through the switch according to a predetermined priority.

3. The method as claimed in claim 1, wherein the step of establishing a connection between a telephone coupled to the broadband modem and the PSTN network through a switch further comprises:
detecting whether the telephone is idle; and
when the telephone is idle, controlling the switch to connect between the telephone and the PSTN network to transmit the incoming call to the telephone.

4. The method as claimed in claim 1, wherein the step of establishing a connection between a telephone coupled to the broadband modem and the PSTN network through a switch further comprises:
detecting whether the telephone is idle;
when the telephone is not idle, transmitting a call-waiting message to the telephone;
detecting whether a notification transmitted from the telephone is received by the broadband modem; and
when receiving the notification, controlling the switch to connect between the telephone and the PSTN network to transmit the incoming call to the telephone.

5. The method as claimed in claim 1, wherein the step of establishing a connection between the telephone and the VoIP network through the switch further comprises:
detecting whether the telephone is idle;
when the telephone is idle, controlling the switch to connect between the telephone and the VoIP network to transmit the incoming call to the telephone.

6. The method as claimed in claim 1, wherein the step of establishing a connection between the telephone and the VoIP network through the switch further comprises:
detecting whether the telephone is idle;
when the telephone is not idle, the broadband modem transmitting a call-waiting message to the telephone;
detecting whether a notification transmitted from the telephone is received by the broadband modem; and
when receiving the notification, controlling the switch to connect between the telephone and the VoIP network to transmit the incoming call to the telephone.

7. A broadband modem comprising:
a first receiving port coupled to a PSTN network for receiving an incoming call from the PSTN network;
a second receiving port coupled to a VoIP network for receiving an incoming call from the VoIP network;
a connecting port coupled to a telephone;
a switch for connecting the telephone to the PSTN network or the VoIP network selectively;
a processor for controlling the connection of the switch, wherein when the incoming call is routed from the first receiving port, the processor establishes a connection between the telephone and the PSTN network through the switch; and when the incoming call is routed from the second receiving port, the processor establishes a connection between the telephone and the VoIP network through the switch.

8. The device as claimed in claim 7, wherein the processor further comprises:
a priority control device for setting and exercising a predetermined priority, wherein when at least two incoming calls are routed from the first receiving port and the second receiving port respectively at the same time, according to the predetermined priority, the processor establishes a connection between the telephone and the VoIP network or the PSTN network through the switch.

9. The device as claimed in claim 7, wherein the processor further comprises:
a detector for detecting whether the telephone is idle, wherein if the incoming call is routed from the first receiving port and the telephone is idle, the processor controls the switch to connect between the telephone and the PSTN network to transmit the incoming call to the telephone; and if the incoming call is routed from the second receiving port and the telephone is idle, the processor controls the switch to connect between the telephone and the VoIP network to transmit the incoming call to the telephone.

10. The device as claimed in claim 7, wherein the processor further comprises:
a detector for detecting whether the telephone is idle, wherein if the incoming call is routed from the first receiving port and the telephone is not idle, the processor transmits a call-waiting message to the telephone, and after receiving a notification transmitted from the telephone, the processor controls the switch to connect between the telephone and the PSTN network to transmit the incoming call to the telephone, and if the incoming call is routed from the second receiving port and the telephone is not idle, the processor transmits a call-waiting message to the telephone, and after receiving a notification transmitted from the telephone, the processor controls the switch to connect between the telephone and the VoIP network to transmit the incoming call to the telephone.
